(19) United States
(12) Patent Application Publication
(10) Pub. No.: US 2025/0095189 A1
(43) Pub. Date: Mar. 20, 2025

(54) INFORMATION PROCESSING APPARATUS, INFORMATION PROCESSING METHOD, AND NON-TRANSITORY STORAGE MEDIUM

(71) Applicant: NEC Corporation, Minato-ku, Tokyo (JP)

(72) Inventors: Ryo KAWAI, Tokyo (JP); Noboru YOSHIDA, Tokyo (JP); Satoshi YAMAZAKI, Tokyo (JP); Tingting DONG, Tokyo (JP); Jianquan LIU, Tokyo (JP); Karen STEPHEN, Tokyo (JP); Naoki SHINDOU, Tokyo (JP); Yuta NAMIKI, Tokyo (JP); Youhei SASAKI, Tokyo (JP)

(73) Assignee: NEC Corporation, Minato-ku, Tokyo (JP)

(21) Appl. No.: 18/832,563

(22) PCT Filed: Feb. 7, 2022
(86) PCT No.: PCT/JP2022/004668

§ 371 Date: Jul. 24, 2024

(51) Int. Cl. G06T 7/70; G06T 7/20; G06V 10/764; G06V 40/16

(52) U.S. Cl. CPC G06T 7/70; G06T 7/20; G06V 10/764; G06V 40/174

(57) ABSTRACT

An information processing apparatus (10) according to the present invention includes: an extraction unit (11) that extracts, using an image analysis technique, a scene of interest from a portion of a first moving image acquired by capturing a player, the portion being determined based on a specified time point; and an output unit (12) that outputs information indicating a position of the scene of interest within the first moving image.

### TECHNICAL FIELD

The present invention relates to an information processing apparatus, an information processing method, and a program.

### BACKGROUND ART

Techniques related to the present invention are disclosed in Patent Documents 1 to 3 and Non-Patent Document 1.

Patent Document 1 discloses a technique of detecting a line of sight of a referee, a recorder, or the like of a sports game, and, based on a detection result, computing a position to be captured by a camera for game photography.

Patent Document 2 discloses a technique of generating a free-viewpoint video by using a multi-viewpoint video in which the same scene is captured from different viewpoints.

Patent Document 3 discloses a technique of computing feature values of a plurality of keypoints of a human body included in an image, searching for an image including a human body in a similar pose or a human body in a similar motion, based on the computed feature values, and classifying the images with a similar pose or motion into the same group.

Patent Document 4 discloses a technique of detecting a gaze state of a spectator, determining an image-capture position, based on a detection result, and causing an unmanned vehicle to fly to the determined image-capture position and thereby capturing an image.

Patent Document 5 discloses a technique of extracting a scene of interest from a moving image, based on a pose of a player.

Patent Document 6 discloses a technique of generating data indicating a game content and a game result, based on motion information of a moving image acquired by capturing a game accompanying motion.

Non-Patent Document 1 discloses a technique related to skeleton estimation of a person.

### RELATED DOCUMENT

### Patent Document

Patent Document 1: Japanese Patent Application Publication No. 2008-5208
Patent Document 2: International Patent Publication No. WO2018/030206
Patent Document 3: International Patent Publication No. WO2021/084677
Patent Document 4: Japanese Patent Application Publication No. 2019-193209
Patent Document 5: Japanese Patent Application Publication No. 2021-141434
Patent Document 6: Japanese Patent Application Publication No. H11-339009

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pages 7291 to 7299

### DISCLOSURE OF THE INVENTION

### Technical Problem

Provision of a highlight video to a viewer by generating the highlight video by taking out and collecting scenes of interest from a moving image acquired by capturing a player of sports, other performance, or the like has been performed. In an operation of generating the highlight video, there is a problem that an operation of selecting a scene of interest to be taken out is troublesome, that is, operability is poor.

As described above, the techniques described in Patent Documents 1 and 4 are techniques that support image capturing, and do not support an operation of generating a highlight video. The technique described in Patent Document 2 processes a captured video and thereby generates a new video, but generates a free-viewpoint video from a multi-viewpoint video as described above, and does not generate a highlight video. The technique described in Patent Document 3 is a technique of searching for an image including a human body in a similar pose or a human body in a similar motion, and classifying the images with a similar pose or motion into the same group, and there is no description relating to generation of a highlight video. The technique described in Patent Document 5 is a technique of extracting a scene of interest, but there is a problem that a time required for processing by a computer increases in a case where a data amount of a moving image to be processed is large. The technique described in Patent Document 6 is a technique of generating data indicating a game content and a game result, and does not generate a highlight video. The technique described in Non-Patent Document 1 is a technique related to skeleton estimation of a person, and there is no description relating to generation of a highlight video.

Each of the techniques of Patent Documents 1 to 6 and Non-Patent Document 1 alone has a problem that cannot solve the above-described problem regarding operability in generating a highlight video.

In view of the above-described problem, one example of objects of the present invention is to provide an information processing apparatus, an information processing method, and a program that solve the problem regarding operability in generating a highlight video.

### Solution to Problem

One aspect of the present invention provides an information processing apparatus including:
an extraction unit that extracts, using an image analysis technique, a scene of interest from a portion of a first moving image acquired by capturing a player, the portion being determined based on a specified time point; and
an output unit that outputs information indicating a position of the scene of interest within the first moving image.

One aspect of the present invention provides an information processing method including,
by a computer:
   extracting, using an image analysis technique, a scene of interest from a portion of a first moving image acquired by capturing a player, the portion being determined based on a specified time point; and
   outputting information indicating a position of the scene of interest within the first moving image.

One aspect of the present invention provides a program causing a computer to function as:
an extraction unit that extracts, using an image analysis technique, a scene of interest from a portion of a first moving image acquired by capturing a player, the portion being determined based on a specified time point; and
an output unit that outputs information indicating a position of the scene of interest within the first moving image.

### Advantageous Effects of Invention

According to one aspect of the present invention, a problem regarding operability in generating a highlight video is solved.

### BRIEF DESCRIPTION OF THE DRAWINGS

The above-described object and other objects, features, and advantages will become more apparent from the following description of suitable example embodiments and the accompanying drawings thereof.

FIG. 1 It is a diagram illustrating one example of a functional block diagram of an information processing apparatus.

FIG. 2 It is a diagram illustrating one example of a hardware configuration of the information processing apparatus.

FIG. 3 It is a diagram for describing processing of a processing unit.

FIG. 4 It is a diagram schematically illustrating one example of information output by the information processing apparatus.

FIG. 5 It is a flowchart illustrating one example of a flow of processing of the information processing apparatus.

FIG. 6 It is a diagram schematically illustrating another example of information output by the information processing apparatus.

FIG. 7 It is a diagram schematically illustrating another example of information output by the information processing apparatus.

FIG. 8 It is a diagram schematically illustrating another example of information output by the information processing apparatus.

### EXAMPLE EMBODIMENT

Hereinafter, example embodiments of the present invention are described with reference to the drawings. Note that, in all the drawings, the same components are denoted by the same reference signs, and description thereof is omitted as appropriate.

### First Example Embodiment

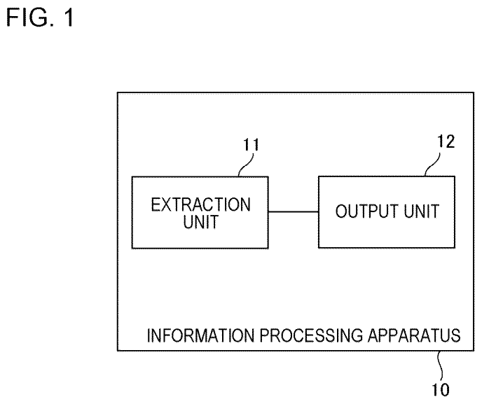

FIG. 1 is a functional block diagram illustrating an outline of an information processing apparatus 10 according to a first example embodiment. The information processing apparatus 10 includes an extraction unit 11 and an output unit 12.

The extraction unit 11 extracts, using an image analysis technique, a scene of interest from a portion in the first moving image acquired by capturing a player of sports or other performance, the portion being determined based on a specified time point. The output unit 12 outputs information indicating the position of the scene of interest within the first moving image.

According to the information processing apparatus 10 with such a configuration, the problem regarding operability in generating a highlight video is solved.

### Second Example Embodiment

### [Outline]

An information processing apparatus 10 according to the present example embodiment is a further embodied description of the information processing apparatus 10 according to the first example embodiment.

The information processing apparatus 10 according to the present example embodiment supports an operation of generating, using an image analysis technique, a highlight video that is a collection of scenes of interest taken out from a first moving image acquired by capturing a player of sports or other performance. Examples of the image analysis technique being used by the information processing apparatus 10 include, but are not limited to, facial recognition, human figure recognition, pose recognition, motion recognition, appearance attribute recognition, image gradient feature detection, image color feature detection, object recognition, and character recognition.

### [Hardware Configuration]

Next, one example of a hardware configuration of the information processing apparatus 10 is described. Functional units of the information processing apparatus 10 are achieved by any combination of hardware and software centering on a central processing unit (CPU) of any computer, a memory, a program loaded into a memory, a storage unit such as a hard disk for storing the program (the storage unit may store, in addition to a program stored in advance from a stage of shipping, even a program downloaded from a storage medium such as a compact disc (CD) or a server or the like on the Internet), and a network-connection interface. It will be understood by those of ordinary skill in the art that there are various modification examples to the implementation method and apparatus thereof.

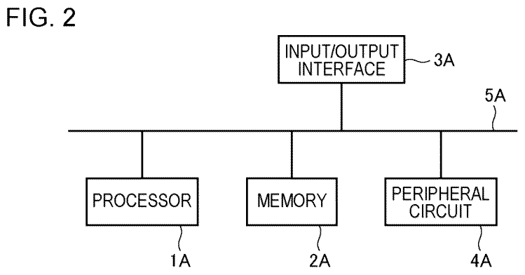

FIG. 2 is a block diagram illustrating a hardware configuration of the information processing apparatus 10. As illustrated in FIG. 2, the information processing apparatus 10 includes a processor TA, a memory 2A, an input/output interface 3A, peripheral circuit 4A, and a bus 5A. The peripheral circuit 4A includes various modules. The information processing apparatus 10 may not necessarily include the peripheral circuit 4A. Note that the information processing apparatus 10 may be constituted by a plurality of physically and/or logically different apparatuses. In such a case, each of the plurality of apparatuses may include the hardware configuration described above.

The bus 5A is a data transmission path through which the processor TA, the memory 2A, the peripheral circuit 4A, and the input/output interface 3A transmit and receive data to and from one another. The processor TA is, for example, an arithmetic processing apparatus such as a CPU or a graphics processing unit (GPU). The memory 2A is, for example, a memory such as a random access memory (RAM) or a read only memory (ROM). The input/output interface 3A includes, for example, an interface for acquiring information from an input device, an external device, an external server, an external sensor, a camera, and the like, and an interface for outputting information to an output device, an external device, an external server, and the like. Examples of the input device include a keyboard, a mouse, a microphone, a physical button, a touch panel, and the like. The output device is, for example, a display, a speaker, a printer, a mailer, or the like. The processor TA can issue a command to each module and perform computation based on the computation results of the modules.

### [Functional Configuration]

Next, a functional configuration of the information processing apparatus 10 according to the present example embodiment is described in detail. FIG. 1 illustrates one example of a functional block diagram of an information processing apparatus 10 according to the present example embodiment. As illustrated, the information processing apparatus 10 includes an extraction unit 11 and an output unit 12.

The extraction unit 11 extracts, using an image analysis technique, a scene of interest in a first moving image acquired by capturing a player. Then, the output unit 12 outputs information indicating the position of the scene of interest (the scene of interest extracted by the extraction unit 11) within the first moving image.

The “player” is a player of sports or other performance. The performance relates to, but is not limited to, songs, music, dancing, dance, plays, dramas, talks, or the like.

The “first moving image” is a moving image being a source of a highlight video. That is, the highlight video is generated from the first moving image.

The “scene of interest” is a scene being a candidate to be included in the highlight video. For example, an operator can determine a scene to be included in the highlight video from among the extracted scenes of interest. The operator can recognize the extracted scene of interest, based on the “information indicating the position of the scene of interest within the first moving image” output by the information processing apparatus 10. The extraction unit 11 extracts a scene of interest in the first moving image by using an image analysis technique.

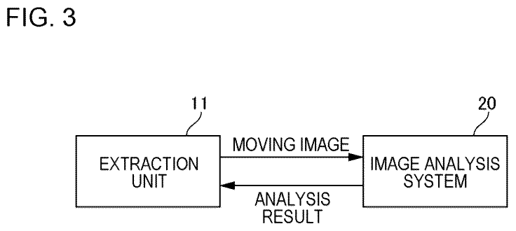

Next, processing of extracting a scene of interest by using an image analysis technique is described. In the present example embodiment, as illustrated in FIG. 3, an image analysis system 20 that analyzes an image and outputs an analysis result is prepared. The image analysis system 20 may be a part of the information processing apparatus 10 or may be an external device physically and/or logically independent from the information processing apparatus 10. The extraction unit 11 utilizes the image analysis system 20 to extract a scene of interest in the first moving image.

Herein, the image analysis system 20 is described. The image analysis system 20 includes at least one of a face recognition function, a human figure recognition function, a pose recognition function, a motion recognition function, an appearance attribute recognition function, an image gradient feature detection function, an image color feature detection function, an object recognition function, and a character recognition function.

In the face recognition function, a person's face feature value is extracted. Furthermore, the similarity between the face feature values may be compared and computed (determination as to whether the persons are the same person, etc.). Further, the extracted face feature value may be compared with face feature values of a plurality of players registered in advance in the database to determine which player the person captured in the image is. In addition, the extracted face feature value may be compared with a face feature value of a player to be detected being registered in the database in advance, and the player to be detected may be detected from the first moving image. The number of players to be detected may be one or more. Note that, the comparison between the extracted face feature value and the face feature value registered in the database in advance may be performed by the image analysis system 20, or may be performed by the extraction unit 11 instead of the image analysis system 20.

In the human figure recognition function, a person's bodily feature value (for example, such feature value refers to an overall feature such as lean/fat body shape, height, and clothes) is extracted. Furthermore, the similarity between the bodily feature values may be compared and computed (determination as to whether the persons are the same person, etc.). Further, the extracted bodily feature value may be compared with bodily feature values of a plurality of human players registered in advance in the database to determine which player the person captured in the image is. In addition, the extracted bodily feature value may be compared with a bodily feature value of a player to be detected being registered in the database in advance, and the player to be detected may be detected from the first moving image. The number of players to be detected may be one or more. Note that, the comparison between the extracted bodily feature value and the bodily feature value registered in the database in advance may be performed by the image analysis system 20, or may be performed by the extraction unit 11 instead of the image analysis system 20.

In the pose recognition function and the motion recognition function, a person's joint points are detected, and a stick man model is constructed by connecting the joint points. Then, by using information related to such stick man model, the height of the person is estimated, the feature value of a pose is extracted, and a motion is determined based on the change in the pose. Furthermore, similarities between the feature values of the pose or between the feature values of the motion may be compared and computed (determination as to whether the poses are the same or the motions are the same, etc.). Further, the estimated height may be compared with the heights of a plurality of players registered in advance in the database to determine which player the person captured in the image is. In addition, the estimated height may be compared with a height of a player to be detected being registered in the database in advance, and the player to be detected may be detected from the first moving image. The number of players to be detected may be one or more. Note that, the comparison between the estimated height and the height registered in the database in advance may be performed by the image analysis system 20, or may be performed by the extraction unit 11 instead of the image analysis system 20.

The pose recognition function and the motion recognition function may be implemented by the techniques disclosed in Patent Document 3 and Non-Patent Document 1.

The appearance attribute recognition function recognizes appearance attributes associated with a person (for example, there are a total of 100 or more kinds of appearance attributes, such as, for example, color of clothes, color of shoes, hairstyle, wearing of hats, ties, and the like). Furthermore, the similarity among the recognized appearance attributes may be compared and computed (it is possible to determine whether the attributes are the same attribute). Further, the recognized appearance attributes may be compared with appearance attributes of a plurality of players registered in advance in the database to determine which player the person captured in the image is. In addition, a player to be detected may be detected from the first moving image by comparing the recognized appearance attribute with the appearance attribute of the player to be detected registered in the database in advance. The number of players to be detected may be one or more. Note that, the comparison between the recognized appearance attribute and the appearance attribute registered in the database in advance may be performed by the image analysis system 20, or may be performed by the extraction unit 11 instead of the image analysis system 20.

The image gradient feature detection function is SIFT, SURF, RIFF, ORB, BRISK, CARD, HOG or the like. According to this function, a gradient feature of each frame image is detected. For example, the detected image gradient feature may be compared with an image gradient feature of a detection target registered in advance in the database, and an image (scene) of the detection target may be detected from the first moving image. Note that, the comparison between the detected image gradient feature and the image gradient feature of the detection target registered in advance in the database may be performed by the image analysis system 20, or may be performed by the extraction unit 11 instead of the image analysis system 20.

In the image color feature detection function, data indicating an image color feature, such as a color histogram, is generated. According to this function, a color feature of each frame image is detected. For example, the detected image color feature may be compared with the image color feature of the detection target registered in advance in the database, and an image (scene) of the detection target may be detected from the first moving image. Note that, the comparison between the detected image color feature and the image color feature of the detection target registered in advance in the database may be performed by the image analysis system 20 or may be performed by the extraction unit 11 instead of the image analysis system 20.

The object recognition function is implemented, for example, by utilizing an engine such as YOLO (which enable extraction of general objects [for example, tools and equipment used in sports and other performances] and extraction of persons). By utilizing the object recognition function, an object can be detected from an image.

In the character recognition function, numbers, characters, and the like are recognized. Further, a number recognized in a region in which a person is captured may be compared with the numbers (uniform numbers, etc.) of a plurality of players registered in advance in the database to determine which player the person captured in the image is. In addition, the number recognized in the region in which the person captured may be compared with a number (uniform number, etc.) of a player to be detected registered in the database in advance, and the player to be detected may be detected from the first moving image. The number of players to be detected may be one or more. Note that, the comparison between the number recognized in the region in which the person is captured with the number (uniform number, etc.) of the player to be detected registered in the database in advance may be performed by the image analysis system 20, or may be performed by the extraction unit 11 instead of the image analysis system 20.

As illustrated in FIG. 3, the extraction unit 11 inputs the first moving image to the image analysis system 20. Then, the extraction unit 11 acquires the analysis result of the first moving image output from the image analysis system 20.

In a case where the face recognition function is utilized, the analysis result output from the image analysis system 20 includes at least one of.
information indicating a face feature value extracted from the first moving image and a position, within the first moving image, of the scene in which each face feature value is extracted;
information indicating a player detected in the first moving image and information indicating a position, within the first moving image, of the scene in which each player is captured; and
information indicating a position, within the first moving image, of a scene in which a player to be detected is captured.

A position of a certain scene within the first moving image is indicated by, for example, an elapsed time from the beginning of the first moving image. The same applies hereinafter.

In a case where the human figure recognition function is utilized, the analysis result output from the image analysis system 20 includes at least one of
information indicating a bodily feature value extracted from the first moving image and a position, within the first moving image, of the scene in which each bodily feature value is extracted;
information indicating a player detected within the first moving image and information indicating a position, within the first moving image, of the scene in which each player is captured; and
information indicating a position, within the first moving image, of a scene in which a player to be detected is captured.

In a case where the pose recognition function and/or the motion recognition function are utilized, the analysis result output from the image analysis system 20 includes at least one of:
information indicating a pose and/or motion detected from the first moving image, and information indicating a position, within the first moving image, of the scene in which each pose and/or motion is captured;
information indicating a player detected within the first moving image and information indicating a position, within the first moving image, of the scene in which each player is captured; and
information indicating a position, within the first moving image, of a scene in which a player to be detected is captured.

In a case where the appearance attribute recognition function is utilized, the analysis result output from the image analysis system 20 includes at least one of:
information indicating an appearance attribute detected from the first moving image, and information indicating a position, within the first moving image, of the scene in which each appearance attribute is detected;
information indicating a player detected within the first moving image and information indicating a position, within the first moving image, of the scene in which each player is captured; and
information indicating a position, within the first moving image, of a scene in which a player to be detected is captured.

In a case where the image gradient feature detection function is utilized, the analysis result output from the image analysis system 20 includes at least one of:
gradient feature of each frame image; and
information indicating a position, within the first moving image, of a scene with a gradient feature similar to that of the image (scene) to be detected.

In a case where the image color feature detection function is utilized, the analysis result output from the image analysis system 20 includes at least one of:
color feature of each frame image; and
information indicating a position, within the first moving image, of a scene with a color feature similar to that of the image (scene) to be detected.

In a case where the object recognition function is utilized, the analysis result output from the image analysis system 20 includes information indicating a position, within the first moving image, of a scene in which an object to be detected is captured.

In a case where the character recognition function is utilized, the analysis result output from the image analysis system 20 includes at least one of:
information indicating a player detected within the first moving image and information indicating a position, within the first moving image, of the scene in which each player is captured; and
information indicating a position, within the first moving image, of a scene in which a player to be detected is captured.

The extraction unit 11 extracts a scene of interest in the first moving image, based on the analysis result output from the image analysis system 20 as described above.

The scene of interest is at least one of:
a scene in which a player in a predetermined pose is captured;
a scene in which a player in a predetermined motion is captured;
a scene in which a predetermined player is captured;
a scene in which a predetermined player in a predetermined pose is captured; and
a scene in which a predetermined player in a predetermined motion is captured.

The predetermined pose, the predetermined motion, and the predetermined player are registered in advance. For example, the image analysis system 20 may be set in such a way that only the predetermined pose, the predetermined motion, and the predetermined player are detected. In addition, the image analysis system 20 may be set in such a way that not only the predetermined pose, the predetermined motion, and the predetermined player, but also other poses, motions, and players are detected. Then, the extraction unit 11 may extract the predetermined pose, the predetermined motion, and the predetermined player from among the poses, motions, and players detected by the image analysis system 20.

For example, by setting a popular player, a player attracting attention, or the like as the predetermined player, a scene in which the popular player, the player attracting attention, or the like is captured may be extracted as the scene of interest. Further, by setting a fist pump, a pose or motion at the time of good play, or the like as the predetermined pose or the predetermined motion, a scene in which a person is giving a fist pump, a scene at the time of good play, or the like may be extracted as the scene of interest. The scene of interest described above is an example, and other scenes may be used as the scene of interest.

Note that, the above-described “scene in which a predetermined object (pose, motion, player, or the like) is captured” may be acquired by collecting only frame images in which the predetermined object is captured, or may be acquired by collecting frame images in which the predetermined object is captured and a predetermined number of frame images before and after such frame image. The predetermined object may not be captured in the “predetermined number of frame images before and after the frame image in which the predetermined object is captured”. In such a case, for example, a play or the like before giving a fist pump may be included in the scene of interest. One scene is composed of at least two consecutive frame images.

After the scene of interest in the first moving image is extracted by the above-described processing, the output unit 12 outputs information indicating the position of the scene of interest within the first moving image. The information indicating the position of the scene of interest within the first moving image is indicated by, for example, the elapsed time from the beginning of the first moving image. In a case where a plurality of scenes of interest are extracted, the output unit 12 outputs information indicating the position of each of the plurality of scenes of interest within the first moving image.

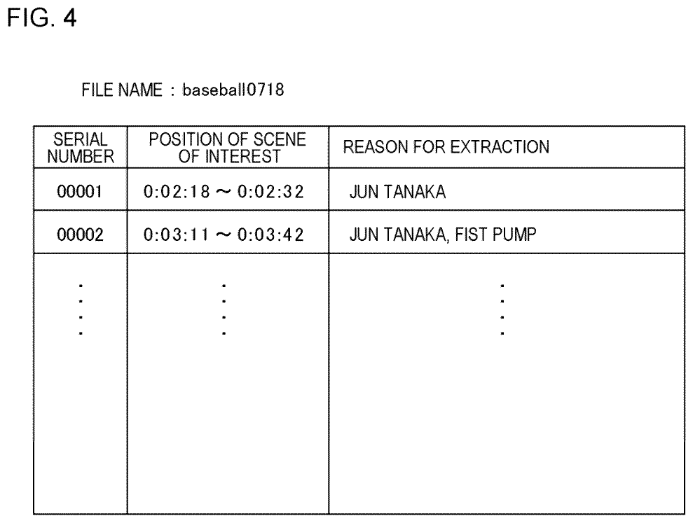

FIG. 4 schematically illustrates one example of information output by the output unit 12. In the information illustrated in FIG. 4, a file name, a serial number, a position of scene of interest, and a reason for extraction are illustrated. Note that, at least the position of scene of interest needs to be illustrated, and other information may not necessarily be displayed.

The “file name” is the file name of the first moving image.

The “serial number” is a number for discriminating a plurality of extracted scenes of interest from one another.

The “position of scene of interest” is information indicating a position of the extracted scene of interest in the first moving image. In the case of the example illustrated in FIG. 4, the position of the scene of interest is indicated by an elapsed time from the beginning of the first moving image.

The “reason for extraction” indicates the reason why the scene of interest has been extracted. For example, a predetermined player, a predetermined pose, a predetermined motion, or the like captured in each scene of interest is indicated as the reason.

For example, in a case where a user input of selecting one of the plurality of scenes of interest listed as illustrated in FIG. 4 is received, the output unit 12 may start reproducing the first moving image from the beginning of the selected scene of interest. The output unit 12 can implement reproduction from the beginning of the selected scene of interest by using the information indicating the position of each scene of interest in the first moving image.

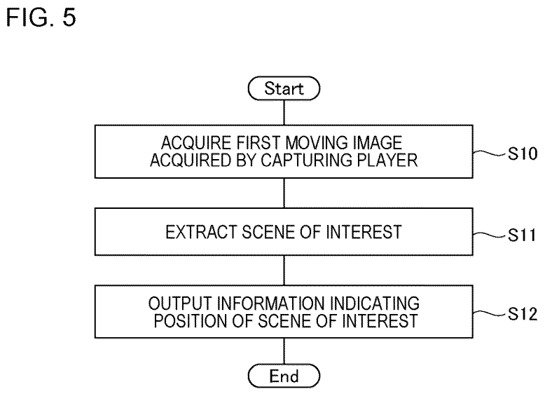

Next, one example of the flow of the processing of the information processing apparatus 10 is described with reference to the flowchart of FIG. 5.

In S10, the information processing apparatus 10 acquires a first moving image acquired by capturing a player. For example, the information processing apparatus 10 acquires a first moving image input by an operator, or acquires, as a first moving image, a moving image specified by the operator from among a plurality of moving image files stored in an accessible storage device.

In S11, the information processing apparatus 10 extracts a scene of interest in the first moving image by using an image analysis technique. For example, the information processing apparatus 10 inputs the first moving image to the image analysis system 20, and then acquires the analysis result of the first moving image output from the image analysis system 20. Then, the information processing apparatus 10 extracts a scene of interest in the first moving image, based on the analysis result.

The scene of interest is at least one of a scene in which a player in a predetermined pose is captured, a scene in which a player in a predetermined motion is captured, a scene in which a predetermined player is captured, a scene in which a predetermined player in a predetermined pose is captured, and a scene in which a predetermined player in a predetermined motion is captured.

In S12, the information processing apparatus 10 outputs information indicating the position of the scene of interest extracted in S11 in the first moving image. The information processing apparatus 10 outputs information as illustrated in FIG. 4, for example.

### Advantageous Effect

The information processing apparatus 10 according to the present example embodiment uses an image analysis technique to extract a scene of interest in the first moving image acquired by capturing the player, and outputs information indicating the position of the scene of interest within the first moving image. An operator who generates a highlight video can select a scene to be included in the highlight video from among the scenes of interest.

Further, the information processing apparatus 10 according to the present example embodiment can analyze the first moving image by using at least one of a face recognition function, a human figure recognition function, a pose recognition function, a motion recognition function, an appearance attribute recognition function, an image gradient feature detection function, an image color feature detection function, an object recognition function, and a character recognition function. Therefore, the scene of interest can be extracted from various viewpoints.

For example, according to the information processing apparatus 10 of the present example embodiment, a scene in which a player in a predetermined pose is captured, a scene in which a player in a predetermined motion is captured, a scene in which a predetermined player is captured, a scene in which a predetermined player in a predetermined pose is captured, a scene in which a predetermined player in a predetermined motion is captured, or the like can be extracted as a scene of interest. As a result, a scene desired by a viewer can be extracted as a scene of interest.

### Third Example Embodiment

An information processing apparatus 10 according to the present example embodiment is different from the first and second example embodiments in that a portion of a first moving image is set as an analysis target which is described above, and other portion of the first moving image can be excluded from the analysis target. Detailed description is made hereinafter.

An extraction unit 11 receives an input specifying a time point. Then, the extraction unit 11 extracts a scene of interest by subjecting a portion of the first moving image to the above-described image analysis, the portion being determined based on the specified time point. The other portion of the first moving image (a portion not determined based on the specified time point) is not subjected to the above-described image analysis.

The “input specifying a time point” is made by, for example, an operator generating a highlight video. The operator inputs approximate time points of a goal scene, a scene where a spectator is excited, and the like.

The “portion determined based on a specified time point” includes frame images captured in a time zone determined based on a specified time point, and is, for example, a portion from a frame image captured a predetermined time before the specified time point to a frame image captured a predetermined time after the specified time point. The predetermined time is a design matter. For example, the extraction unit 11 can determine a frame image captured a predetermined time before a specified time point and a frame image captured a predetermined time after a specified time point, based on time stamps (information indicating a time at which each frame image is captured) of the first moving image.

For example, instead of inputting the entire first moving image to an image analysis system 20, the extraction unit 11 may cut out only a portion determined based on a specified time point from the first moving image, and input only the cut-out portion to the image analysis system 20. In addition, the extraction unit 11 may input the entire first moving image to the image analysis system 20 and also input information indicating a portion to be subjected to the image analysis to the image analysis system 20.

Other configurations of the information processing apparatus 10 according to the present example embodiment are similar to those of the first and second example embodiments.

According to the information processing apparatus 10 of the present example embodiment, similar advantageous effects as those of the information processing apparatuses 10 according to the first and second example embodiments can be achieved.

Further, according to the information processing apparatus 10 of the present example embodiment, it is possible to analyze a portion of the first moving image instead of analyzing the entirety of the first moving image. As a result, reduction of processing load on the image analysis system 20, reduction of time required for the image analysis, and the like are achieved.

For example, the information processing apparatus 10 according to the present example embodiment is advantageous in a case where the operator knows in advance the approximate time point of the goal scene, the exciting scene, or the like.

### Fourth Example Embodiment

An information processing apparatus 10 according to the present example embodiment is different from the first to third example embodiments in further including a function of extracting a scene of interest in a first moving image, based on a result of analyzing a second moving image acquired by capturing a spectator watching a player. Detailed description is made hereinafter.

An extraction unit 11 extracts a scene of interest in a first moving image, based on, in addition to a result of analyzing the first moving image as described in the second and third example embodiments, a result of analyzing a second moving image acquired by capturing a spectator watching a player. Processing of extracting the scene of interest in the first moving image, based on the result of analyzing the first moving image, is similar to that described in the second and third example embodiments.

As illustrated in FIG. 3, the extraction unit 11 inputs the second moving image to an image analysis system 20. Then, the extraction unit 11 acquires the analysis result of the second moving image output from the image analysis system 20.

In a case where a pose recognition function and/or a motion recognition function are utilized, the analysis result output from the image analysis system 20 includes information indicating a pose and/or a motion detected from the second moving image and information indicating a position, within the second moving image, of the scene in which each pose and/or the motion are captured.

In a case where an image gradient feature detection function is utilized, the analysis result output from the image analysis system 20 includes at least one of:
gradient feature of each frame image; and
information indicating a position, within the second moving image, of a scene with a gradient feature similar to that of the image (scene) to be detected.

In a case where an image color feature detection function is utilized, the analysis result output from the image analysis system 20 includes at least one of
color feature of each frame image; and
information indicating a position, within the second moving image, of a scene with a color feature similar to that of the image (scene) to be detected.

In a case where an object recognition function is utilized, the analysis result output from the image analysis system 20 includes information indicating a position, within the second moving image, of a scene in which an object to be detected is captured.

Further, in the case of the present example embodiment, the image analysis system 20 may further include a facial expression detection function. In a case where the facial expression detection function is utilized, the analysis result output from the image analysis system 20 includes information indicating the facial expression of a spectator detected from the second moving image, and information indicating a position, within the second moving image, of the scene in which the spectator of each facial expression is captured.

The extraction unit 11 detects the detection target scene in the second moving image, based on the analysis result of the second moving image being output from the image analysis system 20 as described above.

The detection target scene is at least one of:
a scene in which a spectator in a predetermined pose is captured;
a scene in which a spectator in a predetermined motion is captured; or
a scene in which a spectator with a predetermined facial expression is captured.

The predetermined pose, the predetermined motion, and the predetermined facial expression are registered in advance. For example, the image analysis system 20 may be set in such a way that only the predetermined pose, the predetermined motion, and the predetermined facial expression are detected. In addition, the image analysis system 20 may be set to detect not only the predetermined pose, the predetermined motion, and the predetermined facial expression, but also other poses, motions, and facial expressions. Then, the extraction unit 11 may extract the predetermined pose, the predetermined motion, and the predetermined facial expression from the poses, motions, and facial expressions detected by the image analysis system 20.

For example, by setting a standing pose, a pose in which both hands are raised in joy, a standing-up motion, a motion of jumping up in joy, a delighted facial expression, an excited facial expression, and the like as a predetermined pose, a predetermined motion, or a predetermined facial expression, it is possible to detect a scene such as where a spectator is delighted and excited, as the detection target scene. Note that, the above-described detection target scene is an example, and other scenes may be used as the detection target scene. In addition, the detection target scene may be detected based on audio data of the second moving image. For example, a scene where sound is louder than a reference value may be used as the detection target scene.

The above-described “scene in which a predetermined object (pose, motion, and facial expression) is captured” may be acquired by aggregating only frame images in which the predetermined object is captured, or may be acquired by aggregating a frame image in which the predetermined object is captured and a predetermined number of frame images before and after such frame image. One scene is composed of at least two consecutive frame images.

After detecting the detection target scene in the second moving image in the above-described processing, the extraction unit 11 extracts the scene of interest in the first moving image, based on the detection result. Specifically, the extraction unit 11 extracts, as the scene of interest in the first moving image, a scene in the first moving image captured at same timing as the detection target scene detected in the second moving image. For example, the extraction unit 11 can determine a scene in the first moving image captured at the same timing as the detection target scene detected in the second moving image, based on time stamps (information indicating a time at which each frame image is captured) of the first moving image and the second moving image.

Other configurations of the information processing apparatus 10 according to the present example embodiment are similar to those of the first to third example embodiments.

According to the information processing apparatus 10 of the present example embodiment, similar advantageous effects as those of the information processing apparatuses 10 of the first to third example embodiments can be achieved.

Further, according to the information processing apparatus 10 of the present example embodiment, a scene of interest in a first moving image can be extracted based on a result of analyzing a second moving image acquired by capturing a spectator watching a player. According to such information processing apparatus 10 of the present example embodiment, a scene of interest in the first moving image can be extracted from a viewpoint different from that of the information processing apparatus 10 according to the first example embodiment wherein a scene of interest in a first moving image is extracted based on the result of analyzing a first moving image acquired by capturing a player.

Further, according to the information processing apparatus 10 of the present example embodiment, it is possible to extract, as the scene of interest, a scene within the first moving image captured at the same timing as the scene in the second moving image where a spectator in a predetermined pose, motion, or facial expression is captured. In such a case, for example, a scene where the spectator is delighted and excited can be extracted as the scene of interest.

### Fifth Example Embodiment

An information processing apparatus 10 according to the present example embodiment differs from the first to fourth example embodiments in that information indicating a position of a scene of interest in a first moving image is displayed in a characteristic user interface (UI) screen. Detailed description is made hereinafter.

An extraction unit 11 classifies a scene of interest extracted from a first moving image into a group according to the contents thereof. Then, an output unit 12 outputs, separately for each group, information indicating the position of the scene of interest within the first moving image. For example, the extraction unit 11 classifies the scene of interest into different groups according to a captured player, a captured pose of a player, a captured motion of a player, a pose of a spectator in a moving image captured at same timing, a motion of a spectator in a moving image captured at the same timing, or a facial expression of a spectator in a moving image captured at the same timing. Note that one scene may belong to a plurality of groups.

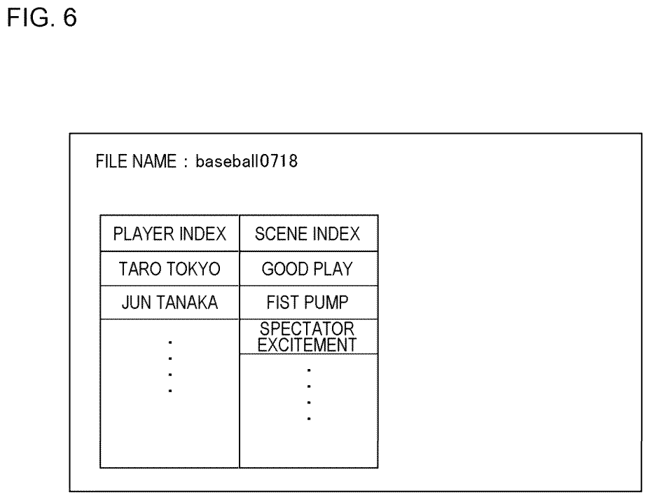

FIG. 6 schematically illustrates one example of a UI screen output by the output unit 12. In the UI screen illustrated in FIG. 6, a file name, a player index, and a scene index are illustrated.

The “file name” is the file name of the first moving image.

The “player index” is a list of names of players captured in the first moving image.

The “scene index” is a list of scenes captured in the first moving image. For example, a scene of a good play, a scene of a fist pump, a scene in which a spectator is excited, and the like.

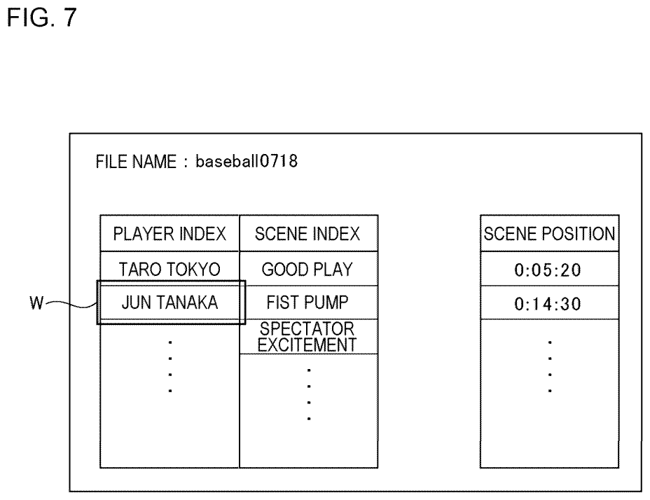

In the UI screen as illustrated in FIG. 6, in a case where a user input selecting one of a plurality of indexes is performed, the output unit 12 may further display, in response to the user input, information relating to a scene position as illustrated in FIG. 7. In the case of an example illustrated in FIG. 7, “Jun Tanaka” surrounded by a frame W is selected by user input. In a scene position column, information indicating a position of a scene of interest in which the selected Jun Tanaka is captured (i.e., a scene of interest the extraction reason of which is Jun Tanaka) is displayed. Note that, in the case of the example illustrated in FIG. 7, the start position of the scene of interest is indicated by the elapsed time from the beginning of the first moving image.

Other configurations of the information processing apparatus 10 according to the present example embodiment are similar to those of the first to fourth example embodiments.

According to the information processing apparatus 10 of the present example embodiment, similar advantageous effects as those of the information processing apparatuses 10 of the first to fourth example embodiments can be achieved.

Further, according to the information processing apparatus 10 of the present example embodiment, it is possible to display information indicating the position of the scene of interest in the first moving image on a characteristic UI screen as illustrated in FIGS. 6 and 7. Specifically, the scene of interest can be classified into a group according to the contents thereof, and information indicating the position of the scene of interest within the first moving image can be output separately for each group. According to the information processing apparatus 10 of the present example embodiment, an operator generating a highlight video can easily find a desired scene of interest from among a plurality of scenes of interest. As a result, the problem regarding operability in generating a highlight video is solved.

### Sixth Example Embodiment

An information processing apparatus 10 according to the present example embodiment is different from the first to fifth example embodiments in that a plurality of first moving images are acquired and information indicating the position of a scene of interest in each of the plurality of first moving images is being output.

In a case where, for example, a player plays in a wide playing area (a baseball stadium, an arena, a concert hall, etc.), or in a case where a plurality of players play at the same time, a plurality of cameras may capture the area or the players. The plurality of first moving images are moving images generated in such a way, by capturing images in the same play area at the same timing by the plurality of cameras. The plurality of cameras may capture mutually different objects (a player, a scoreboard, a clock, a coach, etc.), may capture mutually different places (mutually different places within the same area), or may capture the same object from mutually different angles.

An extraction unit 11 performs the image analysis described in the first to fifth example embodiments on each of the plurality of first moving images. Then, an output unit 12 collectively outputs information indicating the position of the scene of interest within the plurality of first moving images.

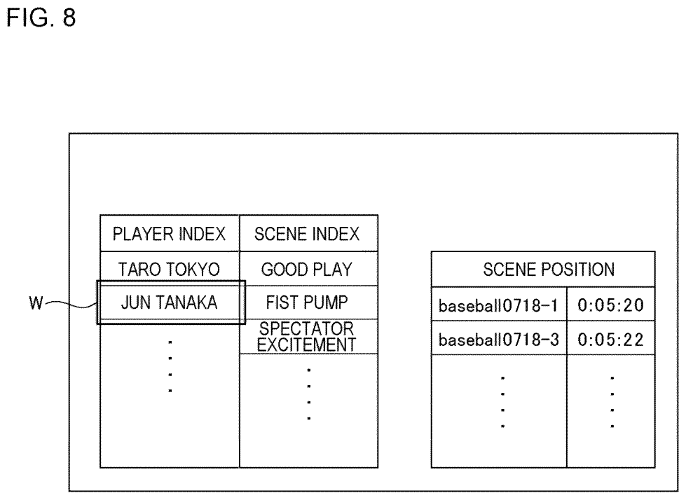

FIG. 8 schematically illustrates one example of a UI screen output by the output unit 12. In the UI screen illustrated in FIG. 8, a player index, a scene index, and a scene position are illustrated.

The “player index” is a list of names of players captured in one of the plurality of first moving images.

The “scene index” is a list of scenes captured in one of the plurality of first moving images. For example, a scene of a good play, a scene of a fist pump, a scene in which a spectator is excited, and the like.

The “scene position” is information indicating a position of an extracted scene of interest within the first moving image. In the case of the example illustrated in FIG. 8, a position, within the first moving image, of a scene of interest belonging to a group selected by an operator is indicated. In the case of the example illustrated in FIG. 8, a group associated with “Jun Tanaka” surrounded by a frame W is currently selected. Therefore, in the scene position column, the position of the scene of interest in which Jun Tanaka is captured is indicated. Note that, in the case of the example illustrated in FIG. 8, the start position of each scene of interest is indicated by information associating the file name of the first moving image with the elapsed time from the beginning of the first moving image. As illustrated, a plurality of scenes of interest extracted from the plurality of moving images are collectively displayed in a list. In addition, the scene position may be displayed in response to selection of one index as in the example described with reference to FIGS. 6 and 7.

### Modification Example

Herein, a modification example of the sixth example embodiment is described. In a case where the technique of the sixth example embodiment is combined with the technique of the third example embodiment of extracting a scene of interest in the first moving image, based on the result of analyzing the second moving image acquired by capturing a spectator watching a player, the information processing apparatus 10 can execute processing as described below.

First, the extraction unit 11 determines which point in the play area the spectator included in the detection target scene detected from the second moving image is watching.

Specifically, the extraction unit 11 determines a direction in which the spectator faces (a direction of his/her line of sight, a direction in which his/her face faces, or a direction in which his/her body faces) by the image analysis. Next, the extraction unit 11 determines the orientation of each of the plurality of cameras at timing when the detection target scene is captured, based on a map of the play area, the installation position of each of the plurality of cameras within the play area, and the background image included in the detection target scene. Then, the extraction unit 11 determines which point in the play area the spectator is watching, based on the map of the play area, the installation position of each of the plurality of cameras in the play area, the orientation of each of the plurality of cameras at the timing when the detection target scene is captured, and the direction in which the determined spectator faces. These processing can be implemented using any associated technology.

In a case where a plurality of spectators are included in the detection target scene, the extraction unit 11 may determine a direction in which each of the plurality of spectators faces, collect statistics thereof, and determine the direction thus computed (the direction in which the most people face, the average of the directions in which the plurality of spectators face) as the direction in which the spectators face.

Note that, at least a part of these processing may be executed by the image analysis system 20.

Next, the extraction unit 11 determines a camera capturing a position in the play area watched by the spectator in the detection target scene, based on the map of the play area, the installation position of each of the plurality of cameras in the play area, the orientation of each of the plurality of cameras at the timing of capturing the detection target scene, and the position in the play area viewed by the spectator in the detection target scene. Then, the extraction unit 11 extracts, as the scene of interest in the first moving image, a scene within the first moving image captured by the determined camera, the scene being captured at the same timing as the detection target scene detected in the second moving image.

Other configurations of the information processing apparatus 10 according to the present example embodiment are similar to those of the first to fifth example embodiments.

According to the information processing apparatus 10 of the present example embodiment, similar advantageous effects as those of the information processing apparatuses 10 of the first to fifth example embodiments can be achieved.

Further, according to the information processing apparatus 10 of the present example embodiment, it is possible to collectively output the positions of the scenes of interest extracted from the plurality of first moving images. In a case where there are a plurality of players playing at the same time, such as baseball, soccer, a concert, or the like, a plurality of cameras may be used to capture the game or the like. In such a case, a more attractive highlight image can be generated by generating a highlight image from a plurality of first moving images captured and generated by a plurality of cameras. However, an operation of viewing each of the plurality of first moving images and selecting portions to be included in the highlight video from each of the plurality of first moving images is very troublesome. According to the information processing apparatus 10 of the present example embodiment that collectively outputs the positions of the scenes of interest extracted from the plurality of first moving images, operation efficiency of selecting the portions to be included in the highlight video from the plurality of first moving images is improved.

Further, according to the above-described modification example of the information processing apparatus 10 of the present example embodiment, it is possible to extract, as the scene of interest, a scene within the first moving image generated by a camera that was capturing a position watched by the spectator at timing when the spectator was delighted and excited, for example.

### MODIFICATION EXAMPLES

Herein, modification examples applicable to the first to sixth example embodiments is described.

### First Modification Example

An extraction unit 11 may compute the stats for each player by detecting a scene in which each of a plurality of players is captured by the above-described technique, and then processing each scene by using a predetermined method. Then, an output unit 12 may output the computed stats.

### Second Modification Example

An image analysis system 20 may detect a plurality of poses and/or motions from the first moving image, and then group similar poses and motions together, and output a result of the grouping. Such processing may be implemented by using the technique described in Patent Document 3. Then, an output unit 12 may output the result of the grouping. Based on the output information, the operator can recognize an outline of what kind of pose and motion are detected from the first moving image. Then, the operator can construct a rough story of the highlight video to be generated, based on the recognized contents. After the story is constructed, a desired scene of interest can be found from the UI screen as illustrated in FIG. 4, 6, 7, or 8, and a highlight video can be generated.

### Third Modification Example

An extraction unit 11 may accept an input of a highlight video generated in the past. Then, the extraction unit 11 may extract, as a scene of interest, a scene in which a player in a similar pose or motion as the player's pose or motion included in a highlight video generated in the past is captured.

In such a case, the extraction unit 11 may generate a highlight video by connecting the plurality of extracted scenes of interest in the same order as the highlight videos generated in the past.

Although the example embodiments of the present invention have been described above with reference to the drawings, these are examples of the present invention, and various configurations other than the above may be adopted. The configurations of the above-described example embodiments may be combined with each other, or some of the configurations may be replaced with other configurations. Further, various modifications may be made in the configurations of the above-described example embodiments within a range not departing from the gist. Further, the configurations and processing disclosed in the above-described example embodiments and modification examples may be combined with one another.

Further, in the plurality of flowcharts used in the description described above, a plurality of steps (processing) are described in order, but the execution order of the steps executed in each example embodiment is not limited to the above-described order. In each of the example embodiments, the illustrated order of the steps can be changed within a range that does not interfere with the contents. Further, the above-described example embodiments can be combined with one another within a range in which the contents do not conflict.

Apart or the whole of the above-described example embodiments may also be described as the following supplementary notes, but are not limited thereto.
1. An information processing apparatus including:
   an extraction unit that extracts, using an image analysis technique, a scene of interest from a portion of a first moving image acquired by capturing a player, the portion being determined based on a specified time point; and
   an output unit that outputs information indicating a position of the scene of interest within the first moving image.
2. The information processing apparatus according to supplementary note 1, wherein
   the scene of interest is a scene in which a player in a predetermined pose or a player in a predetermined motion is captured.
3. The information processing apparatus according to supplementary note 1 or 2, wherein
   the scene of interest is a scene in which a predetermined player is captured.
4. The information processing apparatus according to any one of supplementary notes 1 to 3, wherein
   the extraction unit further extracts the scene of interest in the first moving image, based on a result of analyzing a second moving image acquired by capturing a spectator watching the player.
5. The information processing apparatus according to supplementary note 4, wherein
   the scene of interest is a scene, within the first moving image, captured at same timing as a scene, within the second moving image, in which a spectator in a predetermined pose is captured, a spectator in a predetermined motion is captured, or a spectator with a predetermined facial expression is captured.
6. The information processing apparatus according to any one of supplementary notes 1 to 5, wherein
   the extraction unit classifies the extracted scene of interest into a group according to a content thereof, and
   the output unit outputs, separately for each of the groups, information indicating a position of the scene of interest within the first moving image.
7. The information processing apparatus according to supplementary note 6, wherein
   the extraction unit classifies the scene of interest into different groups according to a captured player, a captured pose of a player, a captured motion of a player, a pose of a spectator in a moving image captured at same timing, a motion of a spectator in a moving image captured at same timing, or a facial expression of a spectator in a moving image captured at same timing.
8. An information processing method including,
   by a computer:
      extracting, using an image analysis technique, a scene of interest from a portion of a first moving image acquired by capturing a player, the portion being determined based on a specified time point; and
      outputting information indicating a position of the scene of interest within the first moving image.
9. A program causing a computer to function as:
   an extraction unit that extracts, using an image analysis technique, a scene of interest from a portion of a first moving image acquired by capturing a player, the portion being determined based on a specified time point; and
   an output unit that outputs information indicating a position of the scene of interest within the first moving image.
10. An information processing apparatus including:
   an extraction unit that extracts, using an image analysis technique, a scene of interest from a first moving image acquired by capturing a player, and classifies the scene of interest into a group according to the contents thereof; and
   an output unit that outputs, separately for each of the groups, information indicating a position of the scene of interest within the first moving image.
11. An information processing method including,
   by a computer:
      extracting, using an image analysis technique, a scene of interest from a first moving image acquired by capturing a player;
      classifying the scene of interest into a group according to the contents thereof; and
      outputting, separately for each of the groups, information indicating a position of the scene of interest within the first moving image.
12. A program causing a computer to function as:
   an extraction unit that extracts, using an image analysis technique, a scene of interest from a first moving image acquired by capturing a player, and classifies the scene of interest into a group according to the contents thereof; and
   an output unit that outputs, separately for each of the groups, information indicating a position of the scene of interest within the first moving image.

### REFERENCE SIGNS LIST

10 Information processing apparatus
11 Extraction unit
12 Output unit
20 Image analysis system
1A Processor
2A Memory
3A Input/output I/F
4A Peripheral circuit
5A Bus

What is claimed is:

1. An information processing apparatus comprising:
at least one memory configured to store one or more instructions; and
at least one processor configured to execute the one or more instructions to:
extract, using an image analysis technique, a scene of interest from a portion of a first moving image acquired by capturing a player, the portion being determined based on a specified time point; and
output information indicating a position of the scene of interest within the first moving image.

2. The information processing apparatus according to claim 1, wherein
the scene of interest is a scene in which a player in a predetermined pose or a player in a predetermined motion is captured.

3. The information processing apparatus according to claim 1, wherein
the scene of interest is a scene in which a predetermined player is captured.

4. The information processing apparatus according to claim 1, wherein
the at least one processor is further configured to execute the one or more instructions to extract the scene of interest in the first moving image, based on a result of analyzing a second moving image acquired by capturing a spectator watching the player.

5. The information processing apparatus according to claim 4, wherein
the scene of interest is a scene, within the first moving image, captured at same timing as a scene, within the second moving image, in which a spectator in a predetermined pose is captured, a spectator in a predetermined motion is captured, or a spectator with a predetermined facial expression is captured.

6. The information processing apparatus according to claim 1, wherein the at least one processor is further configured to execute the one or more instructions to
classify the extracted scene of interest into a group according to a content thereof, and
output, separately for each of the groups, information indicating a position of the scene of interest within the first moving image.

7. The information processing apparatus according to claim 6, wherein
the at least one processor is further configured to execute the one or more instructions to classify the scene of interest into different groups according to a captured player, a captured pose of a player, a captured motion of a player, a pose of a spectator in a moving image captured at same timing, a motion of a spectator in a moving image captured at same timing, or a facial expression of a spectator in a moving image captured at same timing.

8. An information processing method comprising,
by a computer:
extracting, using an image analysis technique, a scene of interest from a portion of a first moving image acquired by capturing a player, the portion being determined based on a specified time point; and
outputting information indicating a position of the scene of interest within the first moving image.

9. A non-transitory storage medium storing a program causing a computer to:
extract, using an image analysis technique, a scene of interest from a portion of a first moving image acquired by capturing a player, the portion being determined based on a specified time point; and
output information indicating a position of the scene of interest within the first moving image.

10. The information processing method according to claim 8, wherein
the scene of interest is a scene in which a player in a predetermined pose or a player in a predetermined motion is captured.

11. The information processing method according to claim 8, wherein
the scene of interest is a scene in which a predetermined player is captured.

12. The information processing method according to claim 8, wherein
the computer further extracts the scene of interest in the first moving image, based on a result of analyzing a second moving image acquired by capturing a spectator watching the player.

13. The information processing method according to claim 12, wherein
the scene of interest is a scene, within the first moving image, captured at same timing as a scene, within the second moving image, in which a spectator in a predetermined pose is captured, a spectator in a predetermined motion is captured, or a spectator with a predetermined facial expression is captured.

14. The information processing method according to claim 8, wherein the computer
classifies the extracted scene of interest into a group according to a content thereof, and
outputs, separately for each of the groups, information indicating a position of the scene of interest within the first moving image.

15. The information processing method according to claim 14, wherein
the program causing the computer to classify the scene of interest into different groups according to a captured player, a captured pose of a player, a captured motion of a player, a pose of a spectator in a moving image captured at same timing, a motion of a spectator in a moving image captured at same timing, or a facial expression of a spectator in a moving image captured at same timing.

16. The non-transitory storage medium according to claim 9, wherein
the scene of interest is a scene in which a player in a predetermined pose or a player in a predetermined motion is captured.

17. The non-transitory storage medium according to claim 9, wherein
the scene of interest is a scene in which a predetermined player is captured.

18. The non-transitory storage medium according to claim 9, wherein
the program causing the computer to extract the scene of interest in the first moving image, based on a result of analyzing a second moving image acquired by capturing a spectator watching the player.

19. The non-transitory storage medium according to claim 18, wherein
the scene of interest is a scene, within the first moving image, captured at same timing as a scene, within the second moving image, in which a spectator in a predetermined pose is captured, a spectator in a predetermined motion is captured, or a spectator with a predetermined facial expression is captured.

20. The non-transitory storage medium according to claim 9, wherein the program causing the computer to
classify the extracted scene of interest into a group according to a content thereof, and
output, separately for each of the groups, information indicating a position of the scene of interest within the first moving image.
